(19) United States
(12) Patent Application Publication
(10) Pub. No.: US 2007/0247848 A1
(43) Pub. Date: Oct. 25, 2007

(54) Sundial apparatus and method

(75) Inventors: Brent Duwe, Newnan, GA (US); Kenneth Earl Ramsey, Fayetteville, GA (US); George Michael Drake, Newnan, GA (US)

Correspondence Address: KING & SPALDING LLP, 1180 PEACHTREE STREET, ATLANTA, GA, 30309-3521, US

(73) Assignee: Cooper Technologies Company, Houston, TX (US)

(21) Appl. No.: 11/406,549

(22) Filed: Apr. 19, 2006

(51) Int. Cl. F21V 33/00

(52) U.S. Cl. 362/253; 362/23; 362/186

(57) ABSTRACT

An sundial apparatus and method is described, the sundial apparatus including at least one light-emitting-diode bulb.

### CROSS-REFERENCE TO RELATED APPLICATIONS

The present application is related to the following co-pending applications: U.S. design patent application Ser. No. 29/246,483, attorney docket number 23667.371, filed on Apr. 18, 2006; U.S. design patent application Ser. No. 29/246,485, attorney docket no. 23667.372, filed on Apr. 18, 2006; U.S. design patent application Ser. No. 29/246,486, attorney docket no. 23667.373, filed on Apr. 18, 2006; and U.S. utility application Ser. No. ______, attorney docket no. 23667.218, filed on Apr. 19, 2006, the disclosures of which are incorporated herein by reference.

### BACKGROUND

The present disclosure relates in general to sundials and in particular to a sundial assembly including at least one light-emitting-diode bulb.

### BRIEF DESCRIPTION OF THE DRAWINGS

FIG. 1 is a perspective view of a sundial assembly according to an embodiment.

FIG. 2 is a top plan view of the sundial assembly of FIG. 1.

FIG. 3 is a partial diagrammatic/partial sectional view of the sundial assembly of FIG. 2, with the partial sectional view taken along line 3-3.

FIG. 4 is an elevational view of an operational mode of a sundial assembly according to another embodiment.

### DETAILED DESCRIPTION

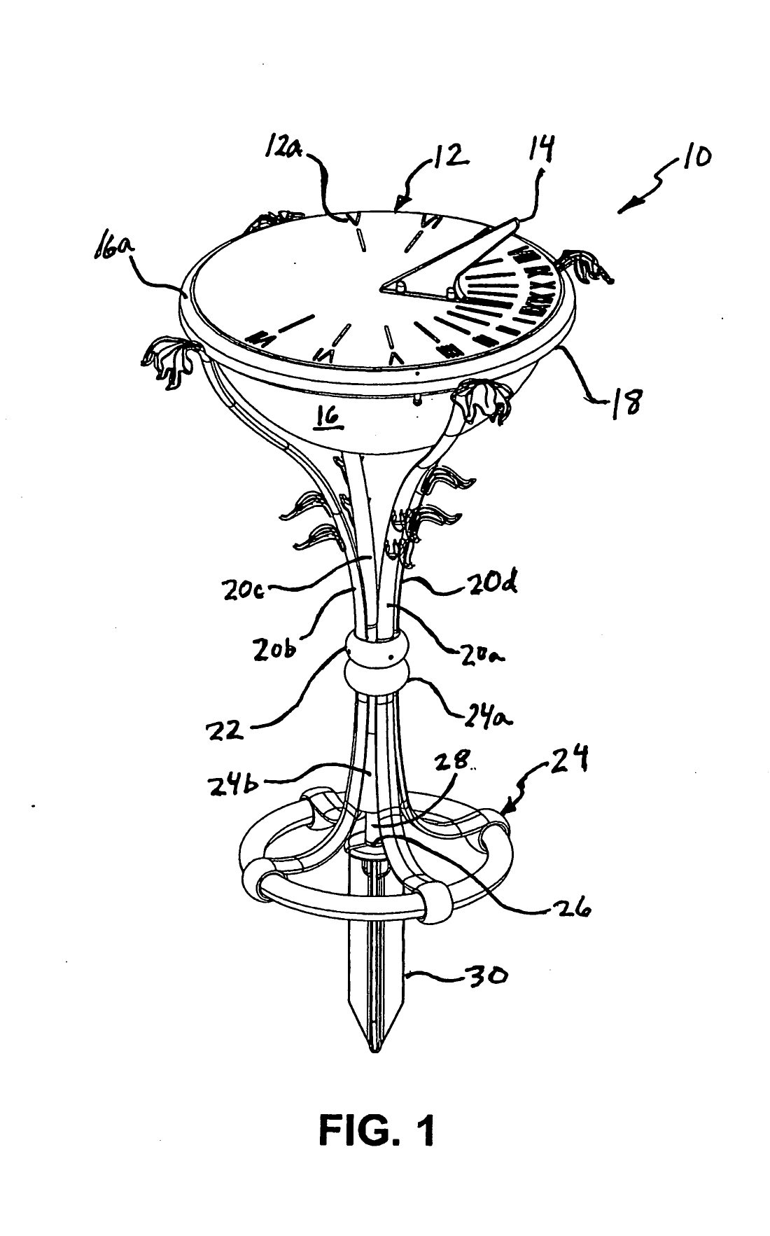

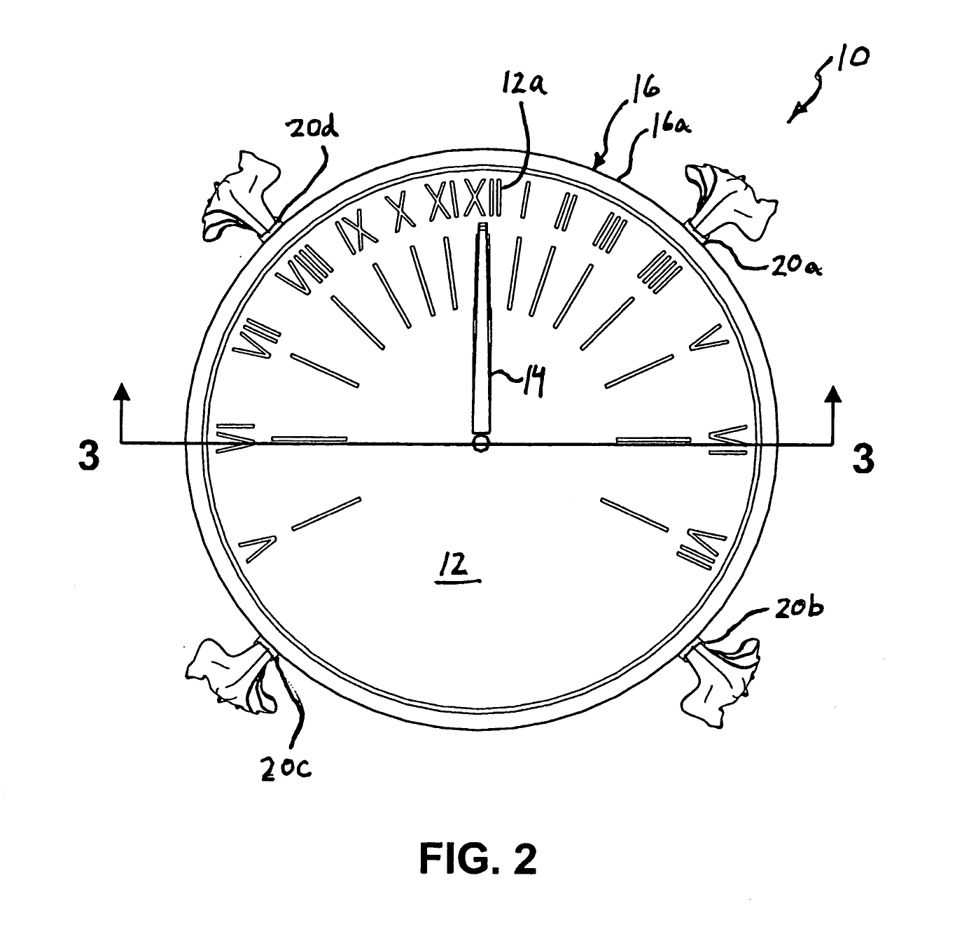

In an exemplary embodiment, as illustrated in FIGS. 1 and 2, a sundial assembly is generally referred to by the reference numeral 10 and includes a sundial top 12 and a gnomon 14 coupled thereto. The sundial top 12 includes a plurality of numbers 12a that mark the hours of the day. In an exemplary embodiment, the sundial top 12 comprises a cast aluminum material. A globe 16 having a lip 16a is coupled to the sundial top 12, and is positioned in a ring 18 so that the lip 16a engages the ring 18 and the ring 18 supports the globe 16. In an exemplary embodiment, the globe 16 is at least partially translucent. In an exemplary embodiment, the globe 16 comprises a marble finish. In an exemplary embodiment, the globe 16 comprises an alabaster glass bowl.

Top braces 20a, 20b, 20c and 20d are coupled to the ring 18 and extend downward therefrom, extending into respective openings in a middle base coupling 22. In an exemplary embodiment, the top braces 20a, 20b, 20c and 20d are secured to the middle base coupling 22 using set screws. The middle base coupling 22 is positioned on a rounded portion 24a of a bottom base 24 having a center sleeve 24b extending downward from the rounded portion 24a. A bottom bolt (not shown) is coupled to the middle base coupling 22, extending downward therefrom and through the rounded portion 24a and the center sleeve 24b, and is further coupled to a bottom base nut 26. A spacer 28 extends between the center sleeve 24b and the bottom base nut 26. As a result, the middle base coupling 22 is coupled to the rounded portion 24a of the base 24. A spike 30 is removably coupled to the bottom base nut 28. In an exemplary embodiment, the assembly 10 is weather resistant using conventional weather-resistant design aspects and/or features such as, for example, conventional weather-resistant finishes.

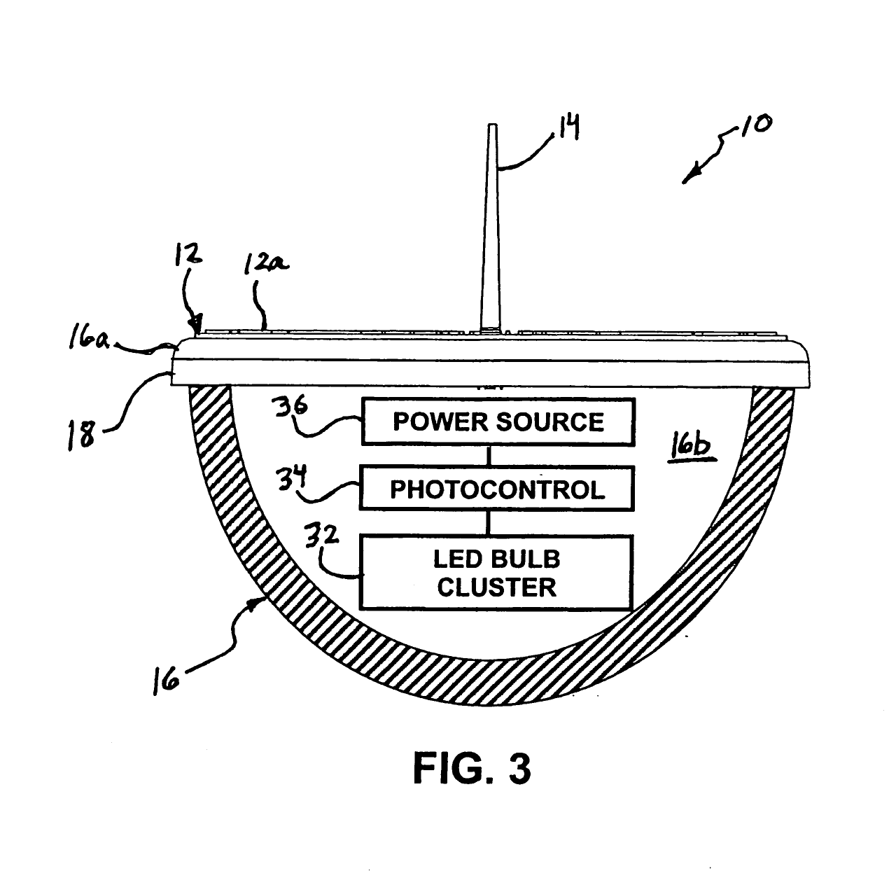

In an exemplary embodiment, as illustrated in FIGS. 1, 2 and 3, the globe 16 defines a region 16b within which a cluster 32 of light-emitting-diode (LED) bulbs is disposed. In an exemplary embodiment, the LED-bulb cluster 32 comprises a single LED bulb. In an exemplary embodiment, the LED-bulb cluster 32 comprises a plurality of LED bulbs. The LED-bulb cluster 32 is operably coupled to a photocontrol 34, which is adapted to control the operation of the LED-bulb cluster 32. In an exemplary embodiment, the photocontrol 34 comprises a photocell. A source of power 36 is operably coupled to the photocontrol 34 and is adapted to supply power to the LED-bulb cluster 32 in an amount sufficient to cause the LED-bulb cluster 32 to illuminate the globe 16, under conditions to be described. In an exemplary embodiment, the source of power 36 comprises one or more batteries. In an exemplary embodiment, the source of power 36 comprises four (4) D cell batteries. In several exemplary embodiments, the photocontrol 34 and/or the source of power 36 is disposed within the region 16b of the globe 16. In an exemplary embodiment, the source of power 36 comprises four (4) D cell batteries that are housed in a battery compartment coupled to the underside of the sundial top 12. In an exemplary embodiment, an on/off switch is operably coupled to the source of power 36.

During installation, the assembly 10 is positioned outdoors and on a ground surface adapted to receive the spike 30 such as, for example, a ground surface in a yard. The spike 30 is driven into the ground and, along with the bottom base 24, provides support to the assembly 10 and facilitates the maintenance of the assembly 10 in an upright position. The above-described weather resistance of the assembly 10 permits the assembly 10 to be positioned in any outdoor location. In an exemplary embodiment, if the on/off switch is operably coupled to the source of power 36, the on/off switch is placed in the on position after positioning the assembly 10 in order to permit the LED-bulb cluster 32 to be powered under conditions to be described. In several exemplary embodiments, the assembly 10 may be positioned in any indoor or outdoor location such as, for example, a patio, a porch, a sunroom, a deck and/or a garden. If the assembly 10 is to be positioned on a solid surface that is not adapted to receive the spike 30, the spike 30 is uncoupled from the bottom base nut 28 before so positioning the assembly 10.

In operation, if the sundial assembly 10 is exposed to the sun in its installation position, the gnomon 14 casts a shadow on the sundial top 12. Using the shadow and the numbers 12a, the sundial top 12 indicates the time of day.

During daytime operation, the photocontrol 34 operates to generally prevent the LED-bulb cluster 32 from illuminating the globe 16. The photocontrol 34 so operates in response to the presence of daylight during daytime operation.

At nightfall, the photocontrol 34 operates to automatically turn the LED-bulb cluster 32 on. That is, as a result of nightfall and the absence of daylight, the photocontrol 34 operates to permit the source of electrical power 36 to supply power to the LED-bulb cluster 32 in an amount sufficient to cause the LED-bulb cluster 32 to illuminate the region 16b of the globe 16. As a result, the globe 16 provides a soft glow of light to the environment surrounding the assembly 10. As a result of the soft glow of light, the visual aesthetics of the assembly 10 and the environment thereabout are enhanced and improved. The properties of the alabaster glass bowl of the globe 16 promotes the provision of the soft glow of light. The LED-bulb cluster 32 continues to so illuminate the globe 16 throughout the night.

At dawn, the photocontrol 34 operates to automatically turn the LED-bulb cluster 32 off. The above-described daytime operation of the assembly 10 is then repeated throughout the day. At nightfall, the above-described nighttime operation of the assembly 10 is then repeated.

The above-described operation of the assembly 10 continues as long as the source of power 36 is able, during nighttime operation and in response to the operation of the photocontrol 34, to continue to supply electrical power in an amount sufficient to cause the LED-bulb cluster 32 to illuminate the globe 16 so that the globe 16 provides a soft glow of light to the environment surrounding the assembly 10.

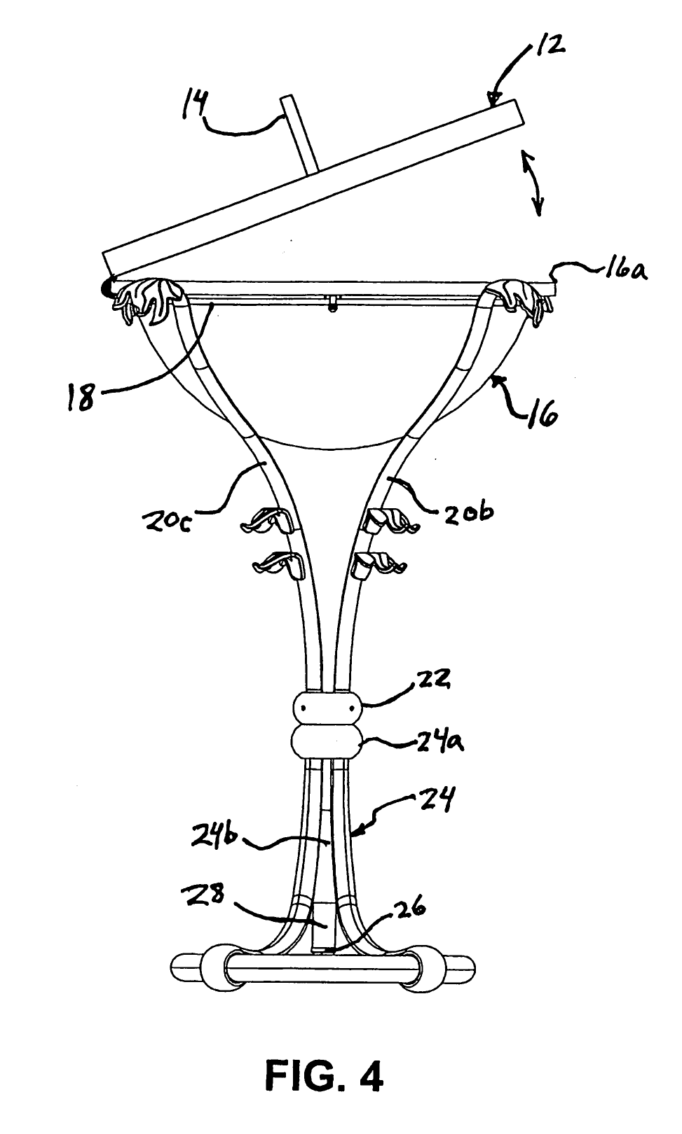

In an exemplary embodiment, as illustrated in FIG. 4, a sundial assembly is generally referred to by the reference numeral 40 and includes several components of the assembly 10 of FIGS. 1-3, which are given the same reference numerals. In the embodiment of FIG. 4, the sundial top 12 is hingedly coupled to the globe 16. In an exemplary embodiment, instead of, or in addition to the globe 16, the sundial top 12 is hingedly coupled to the ring 18. As a result of the hinged coupling of the sundial top 12, the sundial top 12 is permitted to be lifted up, as shown in FIG. 4, to reveal a convenient storage compartment within the region 16b of the globe 16. In several exemplary embodiments, this storage compartment may be used to, for example, store gardening equipment.

As shown in FIG. 4, the assembly 40 does not include the spike 30. As a result, to install the assembly 40, the assembly 40 is positioned on a suitable surface upon which the base 24 rests to support the assembly 40.

The operation of the assembly 40 is substantially similar to the operation of the assembly 10 and therefore the operation of the assembly 40 will not be described in detail.

An apparatus has been described that includes a sundial top; a globe coupled to the sundial top; and at least one LED bulb positioned so that the at least one LED bulb is adapted to illuminate the globe. In an exemplary embodiment, the apparatus comprises a photocontrol operably coupled to the at least one LED bulb. In an exemplary embodiment, the photocontrol comprises a first configuration in which the photocontrol generally prevents the at least one LED bulb from illuminating the globe; and a second configuration in which the photocontrol generally permits the at least one LED bulb to illuminate the globe. In an exemplary embodiment, the photocontrol is placed in the first configuration in response to the presence of daylight; and wherein the photocontrol is placed in the second configuration in response to the absence of daylight. In an exemplary embodiment, the globe defines a region and the at least one LED bulb is disposed in the region. In an exemplary embodiment, the globe comprises an alabaster glass bowl; and wherein, when the at least one LED bulb illuminates the globe, the globe provides a soft glow of light to the environment surrounding the globe.

An apparatus has been described that includes a sundial top; a globe coupled to the sundial top, the globe defining a region and comprising an alabaster glass bowl; at least one LED bulb disposed in the region of the globe so that the at least one LED bulb is adapted to illuminate the globe; and a photocontrol operably coupled to the at least one LED bulb, the photocontrol comprising a first configuration in which the photocontrol generally prevents the at least one LED bulb from illuminating the globe; and a second configuration in which the photocontrol generally permits the at least one LED bulb to illuminate the globe; wherein the photocontrol is placed in the first configuration in response to the presence of daylight; wherein the photocontrol is placed in the second configuration in response to the absence of daylight; and wherein, when the at least one LED bulb illuminates the globe, the globe provides a soft glow of light to the environment surrounding the globe.

A method has been described that includes providing a sundial top and a globe coupled to the sundial top; and controlling the illumination of the globe, comprising controlling the operation of at least one LED bulb positioned so that the at least one LED bulb is adapted to illuminate the globe. In an exemplary embodiment, controlling the operation of the at least one LED bulb positioned so that the at least one LED bulb is adapted to illuminate the globe comprises turning the at least one LED bulb off in response to the presence of daylight; and turning the at least one LED bulb on in response to the absence of daylight. In an exemplary embodiment, the globe defines a region and the at least one LED bulb is disposed in the region. In an exemplary embodiment, the globe comprises an alabaster glass bowl; and wherein, when the at least one LED bulb illuminates the globe, the globe provides a soft glow of light to the environment surrounding the globe.

A method has been described that includes providing a sundial top and a globe coupled to the sundial top, the globe defining a region and comprising an alabaster glass bowl; and controlling the illumination of the globe, comprising controlling the operation of at least one LED bulb disposed in the region so that the at least one LED bulb is adapted to illuminate the globe, comprising turning the at least one LED bulb off in response to the presence of daylight; and turning the at least one LED bulb on in response to the absence of daylight; wherein, when the at least one LED bulb illuminates the globe, the globe provides a soft glow of light to the environment surrounding the globe.

A system has been described that includes means for providing a sundial top and a globe coupled to the sundial top; and means for controlling the illumination of the globe, comprising means for controlling the operation of at least one LED bulb positioned so that the at least one LED bulb is adapted to illuminate the globe. In an exemplary embodiment, means for controlling the operation of the at least one LED bulb positioned so that the at least one LED bulb is adapted to illuminate the globe comprises means for turning the at least one LED bulb off in response to the presence of daylight; and means for turning the at least one LED bulb on in response to the absence of daylight. In an exemplary embodiment, the globe defines a region and the at least one LED bulb is disposed in the region. In an exemplary embodiment, the globe comprises an alabaster glass bowl; and wherein, when the at least one LED bulb illuminates the globe, the globe provides a soft glow of light to the environment surrounding the globe.

A system has been described that includes means for providing a sundial top and a globe coupled to the sundial top, the globe defining a region and comprising an alabaster glass bowl; and means for controlling the illumination of the globe, comprising means for controlling the operation of at least one LED bulb disposed in the region so that the at least one LED bulb is adapted to illuminate the globe, comprising means for turning the at least one LED bulb off in response to the presence of daylight; and means for turning the at least one LED bulb on in response to the absence of daylight; wherein, when the at least one LED bulb illuminates the globe, the globe provides a soft glow of light to the environment surrounding the globe.

Any spatial references such as, for example, “upper,” “lower,” “above,” “below,” “between,” “vertical,” “angular,” “upward,” “downward ,” “side-to-side,” “left-to-right,” “right-to-left,” “top-to-bottom,” “bottom-to-top,” etc., are for the purpose of illustration only and do not limit the specific orientation or location of the structure described above.

It is understood that variations may be made in the foregoing without departing from the scope of the disclosure. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. An apparatus comprising:
a sundial top;
a globe coupled to the sundial top; and
at least one LED bulb positioned so that the at least one LED bulb is adapted to illuminate the globe.

2. The apparatus of claim 1 further comprising:
a photocontrol operably coupled to the at least one LED bulb.

3. The apparatus of claim 2 wherein the photocontrol comprises:
a first configuration in which the photocontrol generally prevents the at least one LED bulb from illuminating the globe; and
a second configuration in which the photocontrol generally permits the at least one LED bulb to illuminate the globe.

4. The apparatus of claim 3 wherein the photocontrol is placed in the first configuration in response to the presence of daylight; and
wherein the photocontrol is placed in the second configuration in response to the absence of daylight.

5. The apparatus of claim 1 wherein the globe defines a region and the at least one LED bulb is disposed in the region.

6. The apparatus of claim 1 wherein the globe comprises an alabaster glass bowl; and wherein, when the at least one LED bulb illuminates the globe, the globe provides a soft glow of light to the environment surrounding the globe.

7. An apparatus comprising:
a sundial top;
a globe coupled to the sundial top, the globe defining a region and comprising an alabaster glass bowl;
at least one LED bulb disposed in the region of the globe so that the at least one LED bulb is adapted to illuminate the globe; and
a photocontrol operably coupled to the at least one LED bulb, the photocontrol comprising:
a first configuration in which the photocontrol generally prevents the at least one LED bulb from illuminating the globe; and
a second configuration in which the photocontrol generally permits the at least one LED bulb to illuminate the globe;
wherein the photocontrol is placed in the first configuration in response to the presence of daylight;
wherein the photocontrol is placed in the second configuration in response to the absence of daylight; and
wherein, when the at least one LED bulb illuminates the globe, the globe provides a soft glow of light to the environment surrounding the globe.

8. A method comprising:
providing a sundial top and a globe coupled to the sundial top; and
controlling the illumination of the globe, comprising:
controlling the operation of at least one LED bulb positioned so that the at least one LED bulb is adapted to illuminate the globe.

9. The method of claim 8 wherein controlling the operation of the at least one LED bulb positioned so that the at least one LED bulb is adapted to illuminate the globe comprises:
turning the at least one LED bulb off in response to the presence of daylight; and
turning the at least one LED bulb on in response to the absence of daylight.

10. The method of claim 8 wherein the globe defines a region and the at least one LED bulb is disposed in the region.

11. The method of claim 8 wherein the globe comprises an alabaster glass bowl; and
wherein, when the at least one LED bulb illuminates the globe, the globe provides a soft glow of light to the environment surrounding the globe.

12. A method comprising:
providing a sundial top and a globe coupled to the sundial top, the globe defining a region and comprising an alabaster glass bowl; and
controlling the illumination of the globe, comprising:
controlling the operation of at least one LED bulb disposed in the region so that the at least one LED bulb is adapted to illuminate the globe, comprising:
turning the at least one LED bulb off in response to the presence of daylight; and
turning the at least one LED bulb on in response to the absence of daylight;
wherein, when the at least one LED bulb illuminates the globe, the globe provides a soft glow of light to the environment surrounding the globe.

13. A system comprising:
means for providing a sundial top and a globe coupled to the sundial top; and
means for controlling the illumination of the globe, comprising:
means for controlling the operation of at least one LED bulb positioned so that the at least one LED bulb is adapted to illuminate the globe.

14. The system of claim 13 wherein means for controlling the operation of the at least one LED bulb positioned so that the at least one LED bulb is adapted to illuminate the globe comprises:
means for turning the at least one LED bulb off in response to the presence of daylight; and
means for turning the at least one LED bulb on in response to the absence of daylight.

15. The system of claim 13 wherein the globe defines a region and the at least one LED bulb is disposed in the region.

16. The system of claim 13 wherein the globe comprises an alabaster glass bowl; and
wherein, when the at least one LED bulb illuminates the globe, the globe provides a soft glow of light to the environment surrounding the globe.

17. A system comprising:
means for providing a sundial top and a globe coupled to the sundial top, the globe defining a region and comprising an alabaster glass bowl; and
means for controlling the illumination of the globe, comprising:
means for controlling the operation of at least one LED bulb disposed in the region so that the at least one LED bulb is adapted to illuminate the globe, comprising:
means for turning the at least one LED bulb off in response to the presence of daylight; and
means for turning the at least one LED bulb on in response to the absence of daylight;
wherein, when the at least one LED bulb illuminates the globe, the globe provides a soft glow of light to the environment surrounding the globe.
